(19) United States
(12) Patent Application Publication
(10) Pub. No.: US 2008/0120136 A1
(43) Pub. Date: May 22, 2008

(54) HEALTH CARE PRODUCT PAYMENT REIMBURSEMENT SYSTEM AND METHOD

(75) Inventor: J. Christopher Barrett, San Diego, CA (US)

Correspondence Address: BAKER & DANIELS LLP, 300 NORTH MERIDIAN STREET, SUITE 2700, INDIANAPOLIS, IN, 46204, US

(73) Assignee: CENTRIC HEALTH FINANCE, La Jolla, CA (US)

(21) Appl. No.: 11/944,209

(22) Filed: Nov. 21, 2007

Related U.S. Application Data
(60) Provisional application No. 60/867,057, filed on Nov. 22, 2006.

(51) Int. Cl. G06Q 50/00

(52) U.S. Cl. 705/2

(57) ABSTRACT

The present invention involves a health care reimbursement method and server for a manufacturer of a product fulfilling an order to health care provider. The method involves purchasing an order from a manufacturer for a predetermined price, for example via a computer server. The method further involves receiving utilization data from a payor; and reconciling the order with the utilization data, both of which may be done by a server. The method may further involve preparing an invoice for the order; and submitting the invoice to the payor, such as by a server. The method may still further involve preparing a second invoice for at least a portion of the order; and submitting the second invoice to a patient, which may be implemented by a server. Further aspects of the method involve receiving payment from the patient; and forwarding the payment to the payor, one or both of which may be done by a server. The method may also include preparing a invoice for at least a portion of the order; and submitting the invoice to a patient.

### RELATED APPLICATIONS

This application claims the benefit of U.S. Provisional Patent Application Ser. No. 60/867,057, filed Nov. 22, 2006, titled HEALTH CARE PRODUCT PAYMENT REIMBURSEMENT SYSTEM AND METHOD, the disclosure of which is expressly incorporated by reference herein.

### BACKGROUND OF THE INVENTION

1. Field of the Invention

The invention relates to the field of health care reimbursement, and more particularly to the distribution of therapeutics and reimbursement for the manufacture and administration of the same.

2. Description of the Related Art

There was a time when people needed medical attention they paid the doctor directly for his or her professional services. Times have changed. Modem medicine can work miracles our grandparents never dreamed of, but sometimes at a staggering price. The provision of critical healthcare treatment is often regarded as a basic human right, regardless of whether the individual has the means to pay—at the same moment some forms of healthcare treatment cost more than a typical family's life savings. These days most Americans rely on a third party—either a private insurer, or a public governmental entity—to help them finance the cost of their medical needs.

Representing over 20 percent of the U.S. Gross Domestic Product, the health care industry is the single largest market in the U.S. today. Although the healthcare industry is a commercial market today, it didn't start out that way. In fact, the origins of these plans resided with providers (doctors and hospitals) and their desire to streamline the financial reimbursement process. In the beginning many managed care plans were formed by providers to provide predictable and reliable payment systems, or by companies to control employee medical costs. Over the course of the twentieth century healthcare plans evolved from being provider run, to adding employer run plans, to being financial institutions for all parties in the health care field much like insurance companies.

Toward the middle of the twentieth century health benefits began to be offered as an incentive to increase employment numbers. In the sixties, Medicare and Medicaid were formed by the Federal Government to help provide medical care to the elderly and poor, respectively. Toward the end of the twentieth century the majority of people were enrolled in some form of health insurance plan, with health maintenance organizations (HMO's) the most common. Today, the healthcare industry is a huge business, with many large managed care companies traded on the stock exchange. The healthcare industry accounts for approximately $1.5 trillion in market revenue.

Prescription drug spending is one of the fastest growing components of national health care spending, increasing at double-digit rates in each of the past 8 years. From 1993 to 2004, the number of prescriptions purchased increased 70% (from 2.0 billion to 3.7 billion), compared to a U.S. population growth of 13%. Additionally, U.S. spending for prescription drugs is projected to increase by 10.7 percent annually through 2013. As a subset of prescription drugs, High-Cost Therapeutics (generally considered to be drugs and treatment methods involving relatively expensive drugs and/or devices) used by specialty Providers (generally referring to medical specialists) for in-office administration represent a growing portion of prescription drug sales.

The added complexities of the current health care system and the sheer volume of medicines being manufactured and administered has resulted in a long payment cycle. The health care provider cannot pay the manufacturer until the provider has received payment from the patient and/or the patient's insurance company or a government assistance program, which might also prove challenging. Today's health care organizations and individual providers face challenges processing and getting reimbursed for medical insurance claims. Shrinking reimbursement margins from governmental Payors under the Medicare Modernization Act of 2003 (“MMA”) and from certain commercial Payors influenced by the pricing paradigm created by the MMA has also put pressure on Providers that buy and bill for high-cost drugs administered in the Provider's office. Additionally, Manufacturers are subject to a variety of third-party influences on the selling price of their product that creates inefficiency and expense in the delivery of such High-Cost Therapeutics.

### SUMMARY OF THE INVENTION

The present invention relates to a health care reimbursement method for a manufacturer of a product fulfilling an order to health care provider. A facilitator maintains an inventory of the product with a distribution services provider. When an order is requested from the inventory, the facilitator credits the manufacturer with a sale for the order of an amount of the product. The facilitator also arranges for shipping the amount of the product to the health care provider; and purchases the receivable created by the order from the manufacturer. Additionally, the faciliator may purchase an order from a manufacturer for a predetermined price, receive utilization data from a payor, and reconcile the order with the utilization data.

[The present invention is an automated business process that removes the therapeutic product component (drugs and devices) from the traditional claims-based reimbursement process currently in place in the health care industry. In this process, a neutral financial and business-process facilitator administers and reconciles claims-level data generated by Providers of healthcare services and drug administration with (i) specific sales and invoicing data from product re-labelers and product resellers applicable to products distributed or supplied to the Provider, (ii) the payment obligations owed by the governmental and/or commercial insurance companies, employers, individuals, and other third-party Payors, and (iii) the payment obligations ultimately owed by the Patients receiving the treatment/therapy from the Provider. The Facilitator may use a software tool that benefits all members of the healthcare services and drug delivery channel by removing layers of cost for the ultimate Payors, mitigating certain risk for Providers by introducing a fee-based system for product administration while providing reporting and administrative checks-and-balances to ensure regulatorily appropriate administration of therapeutics, providing Manufacturers with a streamlined delivery and invoicing system with less third-party pricing influence thereby improving and simplifying reporting to governmental regulators, and assisting Patient care by reducing economic influence in care decisions.

Currently, Payors reimburse product and service components of claims generated by Providers, many of whom “buy and bill” for products used in their practice. These products are sold, distributed, and/or dispensed to such Providers by a variety of suppliers. Most of the entities that “touch” the product in this distribution and delivery channel charge profit from margins charged on the product cost, which ultimately impacts sales price and reimbursement. The present invention facilitates a direct sale between the original seller and the ultimate obligor thereby improving efficiency and achieving cost savings in the product delivery system. The software tool assists with patient enrollment and utilizes an automated batching process to generate purchase proposals to facilitate the sale of the underlying accounts receivable. Importantly, the software tool also maintains claims tracking, detailed reporting, compliance verification, and timely reconciliation that provides the payor and any responsible regulatory agency better transparency into the therapeutic administration which will enhance monitoring and compliance with regulatory mandates for appropriate therapeutic administrations.

The present invention begins when a Payor agrees to work within Facilitator's program (which may be termed “Direct2Payor™” as the program name for the entire suite of services described above), including but not limited to facilitating a direct sale between the original therapeutics seller and the ultimate obligor, reconciliation of claims-level data with sales and invoicing data, invoicing of various claim components, and maintaining claim tracking, detailed reporting, and compliance verification information, while allowing the submission of claims directly to the Payor.

After a Payor has agreed to work within Facilitator's Direct2Payor™ program, the Payor, with or without the assistance of Facilitator, enters into an agreement with a Manufacturer of high-cost therapeutics (“HCT”) to purchase the HCT at a predetermined price. Facilitator then arranges a bulk shipment of therapeutics from the Manufacturer to a Distribution Services Provider (“DSP”). The Payor then informs the Providers about the agreement with Manufacturer and the process for ordering HCT through the DSP. Additionally, some Providers may be aware of the process as a result of previous involvement facilitating the agreement between the Manufacturer and the Payor.

A Provider then places an order with the DSP for a quantity of HCT. The order is filled and the HCT is shipped by the DSP directly to the Provider, generating an account receivable which accrues in Manufacturer 104 for the previously agreed sale price. The account receivable is then sold to Facilitator for an amount agreed upon between the Manufacturer and Facilitator.

After receiving the HCT, the Provider administers the same to the Patient and submits a claim for the HCT and for its administration directly to the Payor, After processing the claim, Payor provides payment to the Provider for the administration portion of the claim.

The claim, including corresponding utilization data, is then forwarded to Facilitator and analyzed, after which the Facilitator generates an invoice for the HCT portion of the claim. Facilitator then forwards the invoice to the Payor and issues a credit with the DSP for the Provider's account or request shipment of replacement HCT from the DSP to the Provider. The Payor provides payment of the invoice amount to Facilitator for the HCT and Facilitator invoices the patient for any financial obligation owing, e.g., a deductible or co-pay amount. The patient then remits payment for the outstanding financial obligation to Facilitator, who remits the same to the Payor.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic representation of the organization in a health care system implementing the methods of the present invention.

FIG. 2 is a flow chart depicting the therapeutics administration and claims reimbursement process according to the methods of the present invention.

Corresponding reference characters indicate corresponding parts throughout the several views. The exemplification set out herein illustrates an embodiment of the invention, in one form, and such exemplification is not to be construed as limiting the scope of the invention in any manner.

### DESCRIPTION OF EMBODIMENTS OF THE PRESENT INVENTION

The embodiment disclosed below is not intended to be exhaustive or limit the invention to the precise form disclosed in the following detailed description. Rather, the embodiment is chosen and described so that others skilled in the art may utilize its teachings.

The detailed descriptions that follow are presented in part in terms of algorithms and symbolic representations of operations on data bits within a computer memory representing alphanumeric characters or other information. These descriptions and representations are the means used by those skilled in the art of data processing arts to most effectively convey the substance of their work to others skilled in the art.

An algorithm is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, symbols, characters, display data, terms, numbers, or the like. It should be borne in mind, however, that all of these and similar terms are to be associated with the appropriate physical quantities and are merely used here as convenient labels applied to these quantities.

Some algorithms may use data structures for both inputting information and producing the desired result. Data structures greatly facilitate data management by data processing systems, and are not accessible except through sophisticated software systems. Data structures are not the information content of a memory; rather they represent specific electronic structural elements that impart a physical organization on the information stored in memory. More than mere abstraction, the data structures are specific electrical or magnetic structural elements in memory that simultaneously represent complex data accurately and provide increased efficiency in computer operation.

Further, the manipulations performed are often referred to in terms, such as comparing or adding, commonly associated with mental operations performed by a human operator. No such capability of a human operator is necessary, or desirable in most cases, in any of the operations described herein that form part of the present invention; the operations are machine operations. Useful machines for performing the operations of the present invention include general-purpose digital computers or other similar devices. In all cases the distinction between the method operations in operating a computer and the method of computation itself should be recognized. The present invention relates to a method and apparatus for operating a computer in processing electrical or other (e.g., mechanical, chemical) physical signals to generate other desired physical signals.

The present invention also relates to an apparatus for performing these operations. This apparatus may be specifically constructed for the required purposes or it may comprise a general purpose computer as selectively activated or reconfigured by a computer program stored in the computer. The algorithms presented herein are not inherently related to any particular computer or other apparatus. In particular, various general-purpose machines may be used with programs written in accordance with the teachings herein, or it may prove more convenient to construct more specialized apparatus to perform the required method steps. The required structure for a variety of these machines will appear from the description below.

The present invention deals with “object-oriented” software, and particularly with an “object-oriented” operating system. The “object-oriented” software is organized into “objects”, each comprising a block of computer instructions describing various procedures (“methods”) to be performed in response to “messages” sent to the object or “events” which occur with the object. Such operations include, for example, the manipulation of variables, the activation of an object by an external event, and the transmission of one or more messages to other objects.

Messages are sent and received between objects having certain functions and knowledge to carry out processes. Messages are generated in response to user instructions, for example, by a user activating an icon with a “mouse” pointer generating an event. Also, messages may be generated by an object in response to the receipt of a message. When one of the objects receives a message, the object carries out an operation (a message procedure) corresponding to the message and, if necessary, returns a result of the operation. Each object has a region where internal states (instance variables) of the object itself are stored and where the other objects are not allowed to access. One feature of the object-oriented system is inheritance. For example, an object for drawing a “circle” on a display may inherit functions and knowledge from another object for drawing a “shape” on a display.

A programmer “programs” in an object-oriented programming language by writing individual blocks of code each of which creates an object by defining its methods. A collection of such objects adapted to communicate with one another by means of messages comprises an object-oriented program. Object-oriented computer programming facilitates the modeling of interactive systems in that each component of the system can be modeled with an object, the behavior of each component being simulated by the methods of its corresponding object, and the interactions between components being simulated by messages transmitted between objects, Objects may also be invoked recursively, allowing for multiple applications of an object's methods until a condition is satisfied. Such recursive techniques may be the most efficient way to programmatically achieve a desired result.

An operator may stimulate a collection of interrelated objects comprising an object-oriented program by sending a message to one of the objects. The receipt of the message may cause the object to respond by carrying out predetermined functions which may include sending additional messages to one or more other objects. The other objects may in turn carry out additional functions in response to the messages they receive, including sending still more messages. In this manner, sequences of message and response may continue indefinitely or may come to an end when all messages have been responded to and no new messages are being sent. When modeling systems utilizing an object-oriented language, a programmer need only think in terms of how each component of a modeled system responds to a stimulus and not in terms of the sequence of operations to be performed in response to some stimulus. Such sequence of operations naturally flows out of the interactions between the objects in response to the stimulus and need not be preordained by the programmer.

Although object-oriented programming makes simulation of systems of interrelated components more intuitive, the operation of an object-oriented program is often difficult to understand because the sequence of operations carried out by an object-oriented program is usually not immediately apparent from a software listing as in the case for sequentially organized programs. Nor is it easy to determine how an object-oriented program works through observation of the readily apparent manifestations of its operation. Most of the operations carried out by a computer in response to a program are “invisible” to an observer since only a relatively few steps in a program typically produce an observable computer output.

In the following description, several terms which are used frequently have specialized meanings in the present context. The term “object” relates to a set of computer instructions and associated data which can be activated directly or indirectly by the user. The terms “windowing environment”, “running in windows”, and “object oriented operating system” are used to denote a computer user interface in which information is manipulated and displayed on a video display such as within bounded regions on a raster scanned video display. The terms “network”, “local area network”, “LAN”, “wide area network”, or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. Users activate computer programs or network resources to create “processes” which include both the general operation of the computer program along with specific operating characteristics determined by input variables and its environment.

The term “Browser” refers to a program which is not necessarily apparent to the user, but which is responsible for transmitting messages between the workstation and the network server and for displaying and interacting with the network user. Browsers are designed to utilize a communications protocol for transmission of text and graphic information over a worldwide network of computers, namely the “World Wide Web” or simply the “Web”. Examples of Browsers compatible with the present invention include the Navigator program sold by Netscape Corporation and the Internet Explorer sold by Microsoft Corporation (Navigator and Internet Explorer are trademarks of their respective owners). Although the following description details such operations in terms of a graphic user interface of a Browser, the present invention may be practiced with text based interfaces, or even with voice or visually activated interfaces, that have many of the functions of a graphic based Browser.

Browsers display information which is formatted in a Standard Generalized Markup Language (“SGML”) or a HyperText Markup Language (“HTML”), both being scripting languages which embed non-visual codes in a text document through the use of special ASCII text codes. Files in these formats may be easily transmitted across computer networks, including global information networks like the Internet, and allow the Browsers to display text, images, and play audio and video recordings. The Web utilizes these data file formats to conjunction with its communication protocol to transmit such information between servers and workstations. Browsers may also be programmed to display information provided in an eXtensible Markup Language (“XML”) file, with XML files being capable of use with several Document Type Definitions (“DTD”) and thus more general in nature than SGML or HTML. The XML file may be analogized to an object, as the data and the stylesheet formatting are separately contained (formatting may be thought of as methods of displaying information, thus an XML file has data and an associated method).

The terms “personal digital assistant” or “PDA”, as defined above, means any handheld, mobile device that combines computing, telephone, fax, e-mail and networking features. The terms “wireless wide area network” or “WWAN” mean a wireless network that serves as the medium for the transmission of data between a handheld device and a computer. The term “synchronization” means the exchanging of information between a handheld device and a desktop computer either via wires or wirelessly. Synchronization ensures that the data on both the handheld device and the desktop computer are identical.

In wireless wide area networks, communication primarily occurs through the transmission of radio signals over analog, digital cellular, or personal communications service (“PCS”) networks. Signals may also be transmitted through microwaves and other electromagnetic waves. At the present time, most wireless data communication takes place across cellular systems using second generation technology such as code-division multiple access (“CDMA”), time division multiple access (“TDMA”), the Global System for Mobile Communications (“GSM”), personal digital cellular (“PDC”), or through packet-data technology over analog systems such as cellular digital packet data (CDPD”) used on the Advance Mobile Phone Service (“AMPS”). The terms “wireless application protocol” or “WAP” mean a universal specification to facilitate the delivery and presentation of web-based data on handheld and mobile devices with small user interfaces.

In relation to the Health Care field, this document uses some terms with specialized meanings. For example, “Facilitator” is a reference to a third party intermediary in the billing and payment process, for example, a generic financial processor. The term “order” refers to an amount of therapeutics or prescriptions that are to be delivered to a health care provider to administer a medical treatment to an individual. The terms “therapeutics,” “prescription,” and “high cost therapeutic” are meant to encompass all of pharmaceutical drugs, medical devices, and other materials used in the provision of health care to an individual. The term “Provider” refers to an individual physician or other health care organizations that are involved in the provision of health care to one or more individuals. The term “Payor” refers to the individual or organization providing some or all direct payment or reimbursement for a health care transaction. The term “Manufacturer” refers to manufacturers, special pharmacies, distributors, and other resellers. The term “Distribution Services Provider” refers to a generic entity capable of storing and distributing a therapeutic.

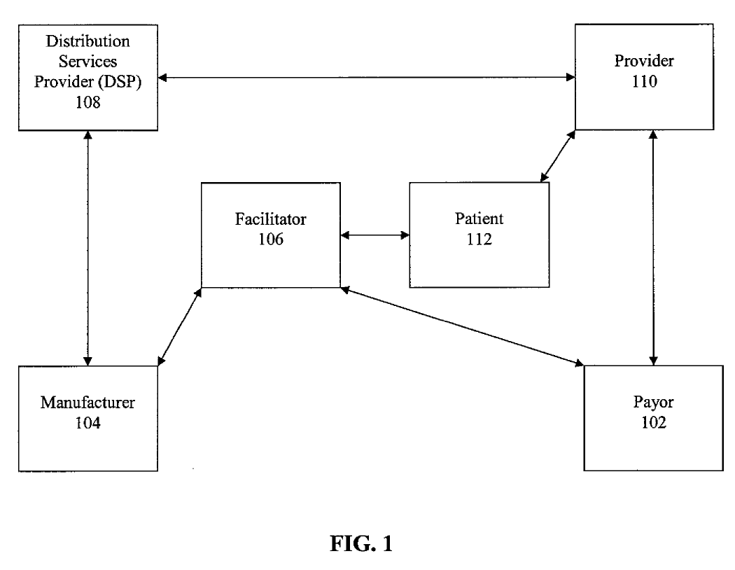

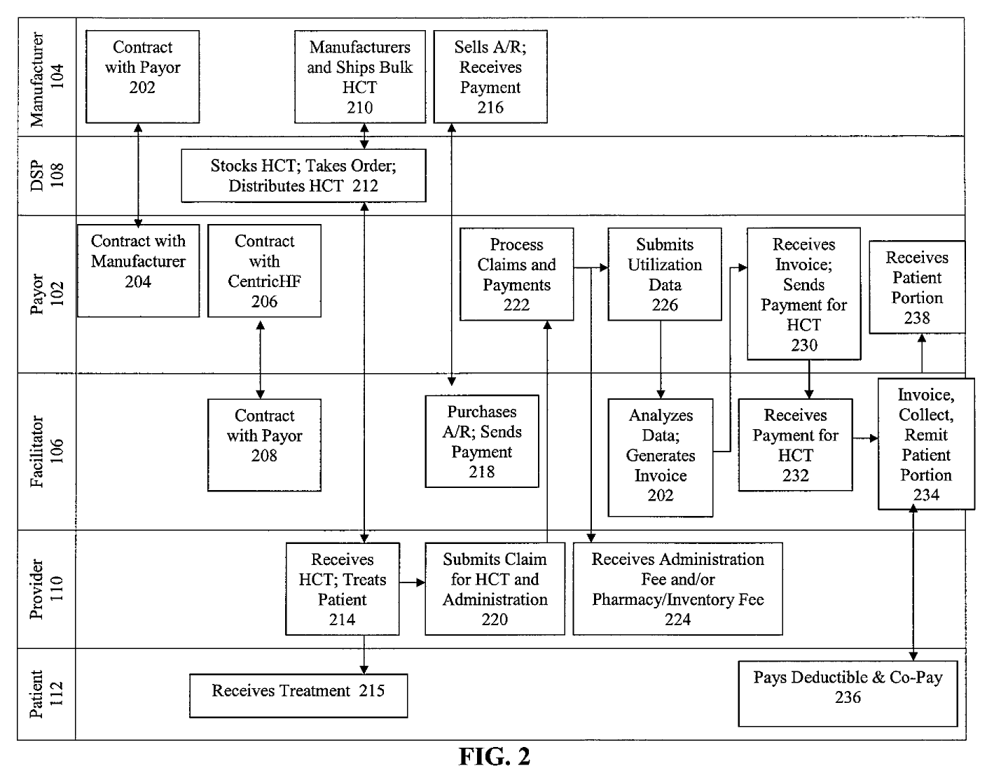

One embodiment of the present invention is depicted in FIGS. 1-2. The process begins when Payor 102, e.g., an insurance company or a public governmental entity, agrees to participate in Facilitator's direct payment system. Payor 102 then enters into a supply agreement with Manufacturer 104, with or without input andlor assistance from Facilitator 106, to provide a HCT at a predetermined price (steps 202, 204 in FIG. 2). This direct negotiation for the purchase of the HCT eliminates third-party price influences and can result in a reduction in the purchase price of the HCT for Payor 102, while allowing Manufacturer 104 to realize net-price sales.

Facilitator 106 then evaluates the particular HCT being sold, the terms under which the HCT is sold, the general sales volume and pricing, and any systems in place for generating invoices and tracking customer credit limits outstanding. In addition, Facilitator 106 may also verify the financial standing of Manufacturer 104. Facilitator 106 then determines the applicable valuation of the accounts receivable Manufacturer 104 will generate under the supply agreement with Payor 102. If Manufacturer 104 and Facilitator 106 arrive at mutually agreeable terms for the valuation of future accounts receivable, Manufacturer 104 and Facilitator 106 enter into a written agreement outlining such terms and the parties' relevant obligations to provide information and/or services to one another (steps 206, 208).

With the agreements between Payor 102 and Manufacturer 104 and between Facilitator 106 and Manufacturer 104 in place, Manufacturer 104 ships a bulk supply of the HCT to DSP 108 (step 210). DSP 108 may be selected by Facilitator 106 and/or Payor 102 and is responsible for maintaining a supply of the HCT and taking orders for and distributing the same. DSP 108 maintains the inventory of the HCT received from Manufacturer 104 on a consignment basis (step 212).

When Provider 110 (such as a doctor, surgeon, or other medical professional), who is aware Payor's 102 participation in the direct payment system of Facilitator 106, requires the HCT to treat Patient 112, who is enrolled in a program administered by Payor 102, Provider 110 submits an order for the HCT directly to DSP 108. By ordering the HCT from DSP 108, Provider 110 is not required to make any payment prior to receiving the HCT and, therefore, does not incur any up-front costs. Additionally, by ordering from DSP 108, Provider 110 is also eligible to receive a drug administration and/or a pharmacy/inventory management fee from Payor 102. After receiving the order from Provider 110, DSP 108 distributes the HCT to Provider 110 (step 212). After receiving the HCT, Provider 110 administers the HCT to Patient 112 (steps 214, 215).

Once Provider 110 places the order for the HCT with DSP 108, a sale for the ordered amount of HCT is recorded by Manufacturer 104. The recordation of the sale results in an account receivable accruing in Manufacturer 104 for the amount agreed upon by Payor 102 and Manufacturer 104. Facilitator 106 receives notice of the new account receivable from the claim submitted by Provider 110 to Payor 102 or, alternatively, may receive notice directly from the order form submitted by Provider 110 to DSP 108. Facilitator 106 then purchases the account receivable from Manufacturer 104 by sending payment, in accordance with their previous agreement, to Manufacturer 104 (step 218). For example, the agreement may provide for the purchase of the HCT for a fixed price for a predetermined period of time. After expiration of the predetermined period of time, the agreement may be renegotiated. Once payment is received and accepted by Manufacturer 104 (step 216), the sale of the account receivable from Manufacturer 104 to Facilitator 106 is concluded. To facilitate payment to Manufacturer 104, Facilitator may submit a purchase proposal to Manufacturer 104 for acceptance. The submission of the purchase proposal and corresponding method of confirming the acceptance thereof by Manufacturer 104 is the subject of U.S. Provisional Patent Application Ser. No. 60/863700, entitled Healthcare Payment Single Payor Facilitation System and Method, the entire disclosure of which is expressly incorporated by reference herein.

After administering the HCT to Patient 112, Provider 110 then generates a claim for the cost and administration of the HCT to Patient 1 12. The claim is then submitted by Provider 110 directly to Payor 102 (step 220). Payor 102 processes the claim and sends payment for the administration portion directly to Provider 110 (step 224). A copy of the claim and corresponding utilization data is then sent to Facilitator 106. For example, the utilization data may include the prescription for the HCT, the order placed with DSP 108, patient information, the date services were provided by Provider 110, CPT codes, and the quantity of the HCT administered. Facilitator 106 analyzes the utilization data and reconciles the amount of HCT reported in the claim with outstanding orders (step 222). Facilitator 106 consolidates the account receivable purchased from Manufacturer 104 until the order is reconciled with a corresponding claim from Provider 110. If the amount of the order and the amount listed on the claim match, Facilitator 106 generates an invoice for the cost of the HCT (step 228) listed on the account receivable purchased from Manufacturer 104. The invoice is forwarded to Payor 102 who sends payment for the HCT directly to Facilitator 106. The reconciliation of the order for the HCT with the claim provides Payor 102 with an indication that the HCT was actually administered by Provider 110.

After receiving payment for the HCT, Facilitator generates an invoice for any outstanding patient component of the claim currently due (steps 232, 234 in FIG. 2). The patient component may be a deductible or co-pay amount due under the agreement between Patient 112 and Payor 102. After receipt of payment from Patient 112, Facilitator 106 forwards the same to Payor 102.

In the event the amount of HCT reported on the claim submitted by Provider 110 does not match with an outstanding order, replacement HCT, corresponding in amount to the amount of HCT administered by Provider 110 to Patient 112, may be sent from DSP 108 to Provider 110. Further, Facilitator 106 confirms whether the HCT was ordered from outside suppliers and sends Provider 110 an order form for future use. Additionally, if Provider 110 did not order the HCT from DSP 108, Provider 110 is not eligible to receive the pharmacy/inventory fee from Payor 102 (step 224). However, Provider 110 may still receive payment at the established rate for any service and/or treatment that was performed during the visit and listed on the claim by diagnosis code(s) and/or CPT code(s).

Further, in the event that the HCT ordered from DSP 108 is not administered to Patient 112 and is later returned, Facilitator 106 may coordinate the restocking of the HCT into the consignment inventory of DSP 108, issue a credit from Manufacturer 104 to Facilitator 106 for the nullified account receivable purchased, and issue a credit from Facilitator 106 to Payor 102 if payment was made on the credited account receivable. This allows Provider 110 to avoid incurring any cost for the HCT if Patient 112 does not receive treatment. In the event the HCT cannot be restocked, Facilitator 106 may coordinate the return and/or credit in accordance with the returned goods policy of Manufacturer 104.

Alternatively, in the event Provider 110 fails to administer the HCT ordered from DSP 108 and, instead of returning it, chooses to keep the HCT, Facilitator 106 will coordinate issuance of a credit to Payor 102 for any amount paid on the account receivable Facilitator 106 purchased from Manufacturer 104. Facilitator 106 will then invoice Provider 110 for the purchase price of the HCT, for the current amount listed on the account receivable purchased from Manufacturer 104.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

We claim:

1. A health care reimbursement method for a manufacturer of a product fulfilling an order to health care provider, comprising the steps of:
a. maintaining an inventory of the product with a distribution services provider;
b. requesting an order from the inventory;
c. crediting the manufacturer with a sale for the order of an amount of the product;
d. shipping the amount of the product to the health care provider; and d.
purchasing the receivable created by the order from the manufacturer.

2. The method of claim 1, further comprising the steps of:
a. receiving information from a payor; and
b. reconciling the information received from the payor with the order.

3. The method of claim 2, wherein the information is utilization data.

4. The method of claim 1, further comprising the step of:
a. preparing an invoice for the order; and
b. submitting the invoice to a payor.

5. The method of claim 1, further comprising the step of:
a. preparing an invoice for at least a portion of the order; and
b. submitting the invoice to a patient.

6. The method of claim 5, further comprising the step of:
a. receiving payment from the patient; and
b. forwarding the payment to a payor.

7. The method of claim 1, further comprising the step of:
a. preparing an invoice for the order; and
b. submitting the invoice to the health care provider.

8. A health care reimbursement method for a manufacturer of a product providing an order to health care provider, comprising the steps of:
a. purchasing an order from a manufacturer for a predetermined price;
b. receiving utilization data from a payor; and
c. reconciling the order with the utilization data.

9. The method of claim 8, further comprising the steps of:
a. preparing an invoice for the order; and
b. submitting the invoice to the payor.

10. The method of claim 9, further comprising the steps of:
a. preparing a second invoice for at least a portion of the order; and
b. submitting the second invoice to a patient.

11. The method of claim 10, further comprising the steps of:
a. receiving payment from the patient; and
b. forwarding the payment to the payor.

12. The method of claim 8, further comprising the steps of:
a. preparing a invoice for at least a portion of the order; and
b. submitting the invoice to a patient.

13. A server for providing health care reimbursement for a manufacturer of a product providing an order to health care provider, comprising:
a. means for purchasing an order from a manufacturer for a predetermined price;
b. means for receiving utilization data from a payor; and
c. means for reconciling the order with the utilization data.

14. The server of claim 13, further comprising:
a means for preparing an invoice for the order; and
b means for submitting the invoice to the payor.

15. The server of claim 14, further comprising:
a. means for preparing a second invoice for at least a portion of the order; and
b. means for submitting the second invoice to a patient.

16. The server of claim 15, further comprising:
a. means for receiving payment from the patient; and
b. means for forwarding the payment to the payor.

17. The server of claim 16, further comprising:
a. means for preparing a invoice for at least a portion of the order; and
b. means for submitting the invoice to a patient.
